(19) United States
(12) Patent Application Publication
(10) Pub. No.: US 2024/0315167 A1
(43) Pub. Date: Sep. 26, 2024

(54) ZERO-TURN MOWER HEIGHT OF CUT WITH FOOT PEDAL OVERRIDE

(71) Applicant: Doosan Bobcat North America Inc., West Fargo, ND (US)

(72) Inventor: Michael Kindel, Bismarck, ND (US)

(21) Appl. No.: 18/598,674

(22) Filed: Mar. 7, 2024

Related U.S. Application Data
(60) Provisional application No. 63/453,886, filed on Mar. 22, 2023.

(51) Int. Cl. A01D 34/74; A01D 101/00

(52) U.S. Cl. CPC A01D 34/74; A01D 2101/00

(57) ABSTRACT

Disclosed are mowers having a mower deck and a suspension system which couples the mower deck to a mower frame. The suspension system includes an actuator coupled to the mower frame, and a mechanical translation system coupled between the actuator and the mower deck. The mechanical translations system is configured to translate actuation positions of the actuator to height positions of the mower deck. A mechanical operator input is coupled to the mechanical translation system, and the translation system is further configured to allow height positions of the mower deck to be temporarily raised by actuation of the mechanical operator input, without further actuation of the actuator, so that frequently encountered obstacles can be quickly avoided without delays required to raise the mower deck with the actuator.

### CROSS-REFERENCE TO RELATED APPLICATION(S)

This application claims the benefit of U.S. provisional application No. 63/453,886, filed on Mar. 22, 2023, the content of which is hereby incorporated by reference in its entirety.

### BACKGROUND

The present disclosure relates to a zero-turn radius (ZTR) mower. More specifically, the present disclosure relates to a ZTR mower that includes height-of-cut control with a mechanical foot pedal override.

ZTR mowers have become a popular type of lawn mowing equipment and include a pair of independently driven rear wheels. The independent drive of the rear wheels allows the ZTR mower to be extremely maneuverable and operable at relative high mowing speeds. ZTR mowers are popular with landscaping companies and homeowners that have a substantial amount of acreage to mow on a regular basis.

ZTR mowers typically include a mower frame, an operator seat or station supported by the mower frame, an engine or other power source which transfers drive power through transaxles or other mechanisms to the pair of rear wheels, a pair of lap bars which control left and right-side drive functions, and a mower deck which houses one or more cutting blades. Typically, the mower deck is coupled to the mower frame by a deck suspension system which allows the height of the mower deck to be adjusted in order to control the height of cut of grass.

Conventionally, hand operated mechanical actuation was utilized with deck suspension systems to control the height of the mower deck. However, increasingly, electric actuators are utilized to control the height of the mower deck to set the height of cut for particular mowing tasks. These electric actuators tend to be relatively slow moving, requiring for example up to ten seconds to adjust the height of the mower deck to a height sufficient to allow the mower to avoid an obstacle, such as jumping a curb when traveling from a street to a lawn. As it is common for many mowing tasks to be performed at a consistently used height of the mower deck, the time required for adjustment of the deck height using such electric actuators is typically acceptable given the infrequent need for making such adjustments. However, as it may be necessary to temporarily adjust the height of the mower deck many times per day to avoid obstacles, the cumulative time required for electric actuation each time can be a significant disadvantage with such electrically actuated height adjustment systems.

The discussion above is merely provided for general background information and is not intended to be used as an aid in determining the scope of the claimed subject matter.

### SUMMARY

Disclosed embodiments include mowers having a mower deck and a deck suspension system which couples the mower deck to a mower frame. The suspension system includes an electric actuator coupled to the mower frame, and a mechanical translation system coupled between the electric actuator and the mower deck. The mechanical translations system is configured to translate actuation positions of the actuator to height positions of the mower deck. A mechanical operator input is coupled to the mechanical translation system, and the translation system is further configured to allow height positions of the mower deck to be temporarily raised by actuation of the mechanical operator input, without further actuation of the actuator, so that frequently encountered obstacles can be quickly avoided without delays required to raise the mower deck with the actuator.

In an exemplary embodiment, a mower includes a mower frame and a mower deck housing one or more cutting blades. A deck suspension system couples the mower deck to the mower frame, and the deck suspension system is configured to control a height of the mower deck and to allow the height of the mower deck to be adjusted. The deck suspension system includes an actuator coupled to the mower frame. The deck suspension system also includes a mechanical translation system coupled between the actuator and the mower deck, the mechanical translations system configured to translate actuation positions of the actuator to height positions of the mower deck such that the actuator controls the height position of the mower deck. The deck suspension system also includes a mechanical operator input, for example a foot pedal, coupled to the mechanical translation system, wherein the mechanical translation system is further configured to allow height positions of the mower deck to be temporarily raised by actuation of the mechanical operator input without further actuation of the actuator.

In some embodiments in which the mechanical operator input is a foot pedal, the actuator and mechanical translation system are configured such that for a first actuated position of the actuator, the mower deck is positioned at a first height, and wherein the mechanical translation system is further configured such that actuation of the foot pedal from a first foot pedal position to a second foot pedal position causes the mower deck to be raised to a second height higher than the first height while the actuator remains at the first actuated position.

In some embodiments, the actuator is a push only linear actuator having an actuator rod, wherein the actuator is configured to apply force to extend the rod to commanded positions and to prevent the rod from being pushed in or retracted by external forces from the commanded positions, and wherein the actuator is unable to retract the rod under power or to prevent the rod from being pulled into an extended position beyond the commanded positions. The mechanical translation system is configured in some embodiments such that the rod of the linear actuator is pulled from the first actuated position to a second position corresponding to the second mower deck height when the foot pedal is actuated from the first foot pedal position to the second foot pedal position. The rod of the linear actuator is pushed from the second position back to the first actuated position, when the foot pedal is no longer actuated, by a force generated from gravitational forces from the weight of the mower deck.

In some embodiments, the mechanical translation system includes a first cross-member; a second cross-member; first and second L-shaped brackets connected to the first cross-member such that rotation of the first cross-member causes rotation of the first and second L-shaped brackets; third and fourth L-shaped brackets connected to the second cross-member such that rotation of the second cross-member causes rotation of the third and fourth L-shaped brackets; a first link coupled between the first and third L-shaped brackets such that rotation of either of the first and third L-shaped brackets causes rotation of the other of the first and third L-shaped brackets; a second link coupled between the second and fourth L-shaped brackets such that rotation of either of the second and fourth L-shaped brackets causes rotation of the other of the second and fourth L-shaped brackets, wherein the mower deck is suspended from the first, second, third and fourth L-shaped brackets such that rotation of the L-shaped brackets raises or lowers the mower deck; and an actuator link having a first end pivotally coupled to an end of the rod of the linear actuator and having a second end coupled to one of the first and second cross-members such that extension of the rod of the actuator causes rotation of the first and second cross-members and of the L-shaped brackets.

In some exemplary embodiments, the actuator is a push-pull linear actuator having an actuator rod, and the actuator is configured to apply force to extend the rod to commanded positions and to prevent the rod from being pushed in or retracted by external forces from the commanded positions, and the actuator is further configured to apply a force to retract the rod under power or to prevent the rod from being pulled into an extended position beyond the commanded positions. In some embodiments, the mechanical translation system is configured such that the rod of the linear actuator remains at the first actuated position when the foot pedal is actuated from the first foot pedal position to the second foot pedal position corresponding to the second mower deck height. In some embodiments,

In some embodiments, the mechanical translation system comprises a first cross-member; a second cross-member; first and second L-shaped brackets connected to the first cross-member such that rotation of the first cross-member causes rotation of the first and second L-shaped brackets; third and fourth L-shaped brackets connected to the second cross-member such that rotation of the second cross-member causes rotation of the third and fourth L-shaped brackets; a first link coupled between the first and third L-shaped brackets such that rotation of either of the first and third L-shaped brackets causes rotation of the other of the first and third L-shaped brackets; a second link coupled between the second and fourth L-shaped brackets such that rotation of either of the second and fourth L-shaped brackets causes rotation of the other of the second and fourth L-shaped brackets, wherein the mower deck is suspended from the first, second, third and fourth L-shaped brackets such that rotation of the L-shaped brackets raises or lowers the mower deck; a seating bracket having a first end pivotally coupled to an end of the rod of the linear actuator such that extension of the rod of the actuator causes rotation of the seating bracket to a seating bracket position corresponding to the first height of the mower deck; and an actuator link configured to be seated by the seating bracket and to rotate with the seating bracket with extension of the rod of the actuator, the actuator link having a first end pivotally coupled to one of the first and second cross-members such that extension of the rod of the actuator causes rotation of the seating bracket, the actuator link, the first and second cross-members and the L-shaped brackets, wherein the actuator link is configured to rotate from seating bracket, while the seating bracket remains at the seating bracket position corresponding to the first height of the mower deck, with the first and second cross-members and with the L-shaped brackets when the foot pedal is actuated from the first foot pedal position to the second foot pedal position to raise the mower deck to the second height.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 is a block diagram illustrating functional systems of a representative power machine on which embodiments of the present disclosure can be advantageously practiced.

FIG. 2 illustrates a perspective view of a representative power machine in the form of a ZTR mower of the type on which disclosed mower deck suspension system embodiments can be practiced.

FIGS. 3-4 illustrate perspective views of a mower deck housing and mower deck suspension system of the ZTR mower illustrated in FIG. 2.

FIG. 5 is a perspective view of the mower deck suspension system illustrated in FIGS. 2-4.

FIG. 6 is a side view of the mower deck housing and mower deck suspension system illustrated in FIGS. 2-5.

FIGS. 7-8 are side views of an alternate embodiment of a mower deck suspension system.

### DETAILED DESCRIPTION

The concepts disclosed in this discussion are described and illustrated by referring to illustrative embodiments. These concepts, however, are not limited in their application to the details of construction and the arrangement of components in the illustrative embodiments and are capable of being practiced or being carried out in various other ways. The terminology in this document is used to describe illustrative embodiments and should not be regarded as limiting. Words such as “including,” “comprising,” and “having” and variations thereof as used herein are meant to encompass the items listed thereafter, equivalents thereof, as well as additional items.

Disclosed embodiments include power machines such as ZTR mowers having a mower deck, housing one or more cutting blades, with the mower deck coupled to a mower frame by a suspension system which includes an actuator that controls the height of the mower deck. The suspension system of disclosed embodiments is configured to allow the mower deck height to be temporarily raised by actuation of a mechanical operator input, over-riding the actuator-controlled height, to allow the mower deck height to be quickly adjusted to avoid contact with obstacles such as tree roots, curbs, rocks, etc. Upon release of the mechanical operator input, the mower deck height is returned to the height controlled by the actuator.

In some disclosed embodiments, a push only linear actuator is utilized to raise the height of the mower deck to establish a particular height of cut. The push only actuator is configured to apply a push force to extend a rod of the actuator, but does not apply a force to retract the rod of the actuator or to prevent the rod from being pulled into positions beyond a user commanded position. This allows a mechanical user input, such as a foot pedal, to be used to temporarily raise the mower deck, as actuation of the foot pedal raises the mower deck and pulls the rod of the push only actuator to a corresponding extended position, but release of the mechanical user input results in the mower deck being lowered by its own weight and the rod of the actuator being pushed in until the actuated position of the actuator is reached.

In other disclosed embodiments, a conventional push-pull linear actuator is utilized to raise and lower the height of the mower deck to establish a particular height of cut. Under normal operation, the height of the mower deck is established by push or pull actuation to raise or lower the deck. In order to quickly raise the mower deck height using a mechanical user input, a mechanism is provided which allows the temporary decoupling of the mower deck height from actuated position of the actuator.

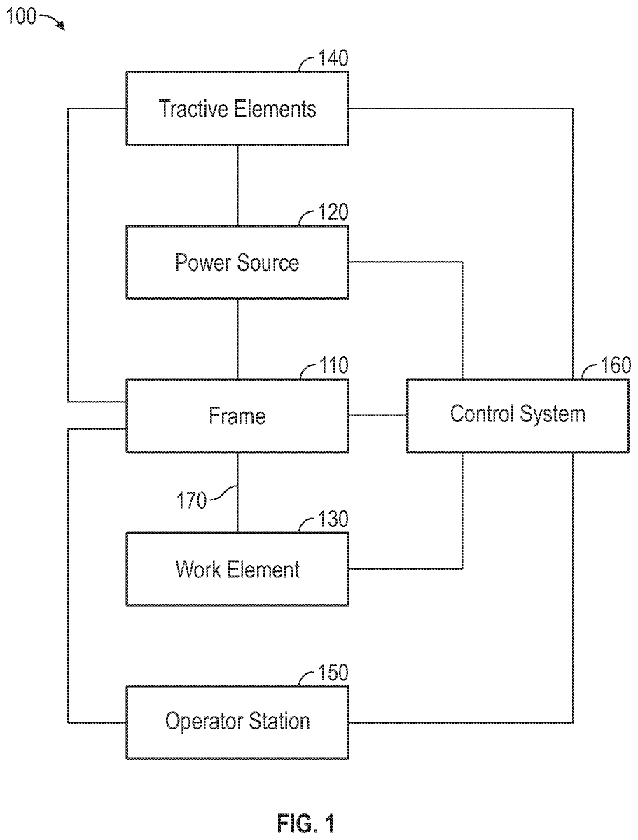

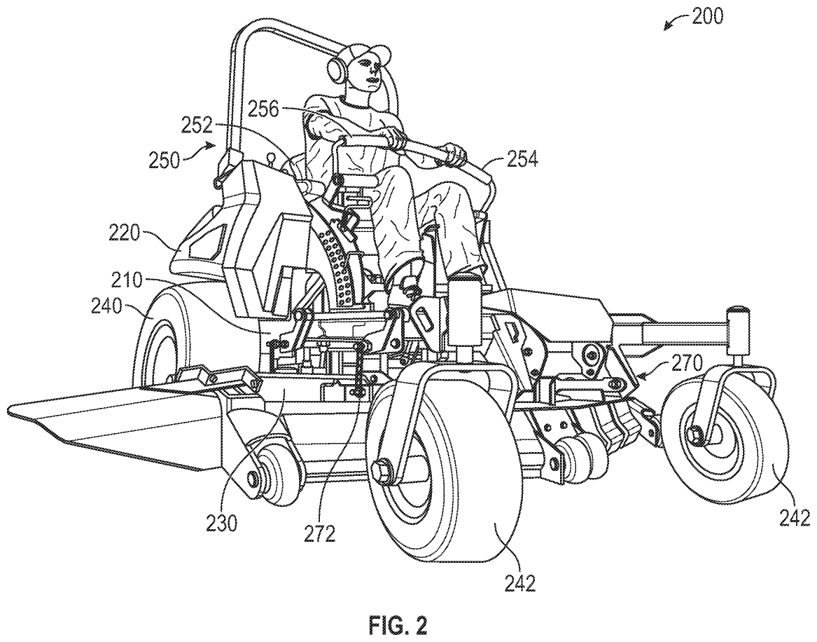

These features, and the more general concepts, can be practiced on various power machines, as will be described below. A representative power machine on which the embodiments can be practiced is illustrated in diagram form in FIG. 1 and one example of such a power machine is illustrated in FIG. 2 and described below before particular embodiment are disclosed. For the sake of brevity, only one power machine is discussed. However, as mentioned above, the embodiments below can be practiced on any of a number of power machines, including power machines of types different from the representative power machines shown in FIGS. 1-2. Power machines, for the purposes of this discussion, include a frame, at least one work element, and a power source that can provide power to the work element to accomplish a work task. One type of power machine is a self-propelled work vehicle, such as a ZTR mower. Self-propelled work vehicles are a class of power machines that include a frame, work element, and a power source that can provide power to the work element. At least one of the work elements is a motive system for moving the power machine under power. In ZTR mowers, at least one work element is a mower deck which is powered by the power source and connected to the mower frame by a deck suspension system to allow the height of the mower deck to be adjusted to control the height of cut, to avoid obstacles, or for other reasons such as loading and unloading the mower from a trailer.

Referring now more specifically to FIG. 1, a block diagram illustrates basic systems of a power machine 100 upon which the embodiments discussed below can be advantageously incorporated. The power machine can be any of a number of different types of power machines, and in particular can be a mower such as a ZTR mower. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140. Power from the power source 120 can be provided directly to any of the work elements 130 or tractive elements 140. Alternatively, power from the power source 120 can be provided to a control system 160, which in turn selectively provides power to the elements that capable of using it to perform a work function. Power sources for power machines typically include an engine such as an internal combustion engine and a power conversion system such as a mechanical transmission or a hydraulic system that can convert the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. In ZTR mower embodiments of power machine 100, work element 130 includes a mower deck which houses at least one blade for cutting. The mower deck work element is connected to the frame 110 of the power machine by a suspension system 170 which includes one or more actuators that, together with other suspension system components, are used to control the height of the mower deck above the surface and thereby control the height of cut. In addition, tractive elements 140 are a special case of work element in that their work function is generally to move the power machine 100 over a support surface. Power machines can have any number of tractive elements, some, or all of which can receive power from the power source 120 to propel the power machine 100. Tractive elements can be, for example, track assemblies, wheels attached to an axle, and the like. In the disclosed ZTR mower embodiments, tractive elements 140 include a pair of individually driven rear wheels. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Referring now to FIG. 2, shown is a perspective view of a more particular an embodiment of the power machine shown in FIG. 1. Power machine 200 is a ZTR mower in exemplary embodiments. Mower 200 has a frame 210 which supports a power source 220, an operator station 250, and a work element in the form of mower deck 230. Power source 220 can be any suitable power source configured to provide power for the tractive elements 240, the mower deck 230, and any other work element functions. For example, power source 220 can be an internal combustion engine with a transaxle, an electric power system, a hybrid power system, etc.

Operator station 250 can include a seat 252, though in other embodiments a platform for the operator to stand on can be included instead. At the operator station 250, a pair of left and right operator inputs 254 and 256, for example in the form of lap bars, are provided and coupled to a control system (not shown) to control power to tractive elements 240 in the form of left and right rear drive wheels. Mower 200 also includes a pair of non-powered front caster wheels 242.

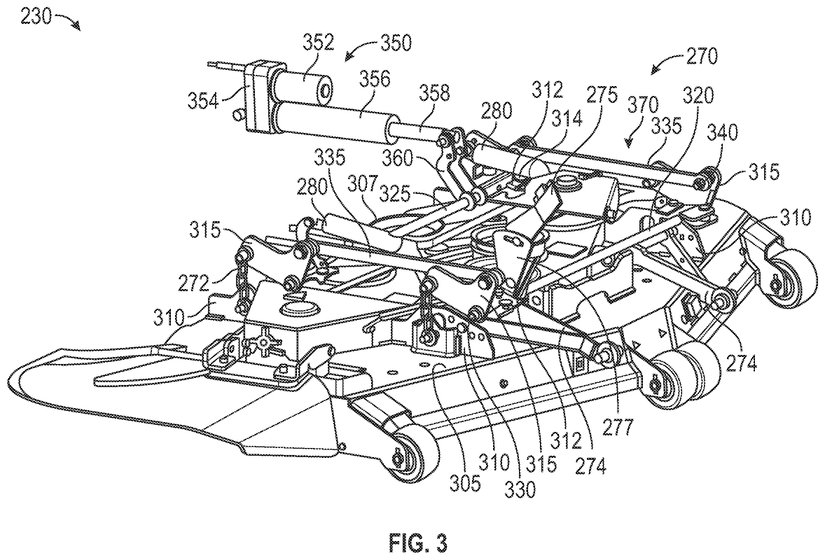

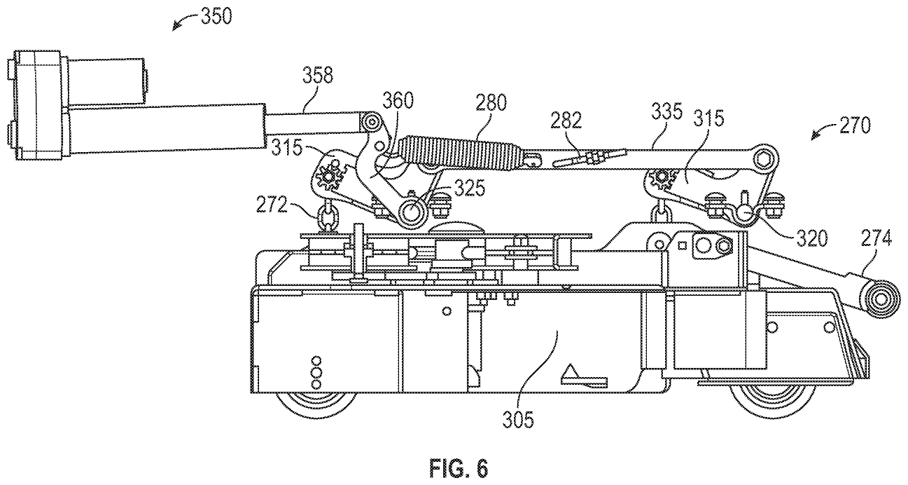

Mower deck 230 is connected to and supported by mower frame 210 by a suspension system 270. Suspension system 270 includes an height adjustment actuator and a mechanical translation mechanism which translates actuation position of the actuator to a height position of the mower deck suspended from the mechanical translation mechanism by a set of chains 272. Mower 200 also includes a mechanical user input override which allows the mower deck to be temporarily rapidly raised from the mower deck height commanded by the actuator. This allows the operator to temporally adjust the height of the mower deck, in a shorter period of time than is required when using the actuator to adjust the deck height, to avoid obstacles such as tree roots, curbs, rocks, to load the mower on or unload the mower from a trailer, etc. The mechanical user input override, for example in the form of a foot pedal, allows the mower deck to quickly return to the actuated height without requiring a change of actuation position of the electric actuator once the obstacle has been traversed. Components of the suspension system of an exemplary embodiment are discussed in further detail with reference to FIGS. 3-6.

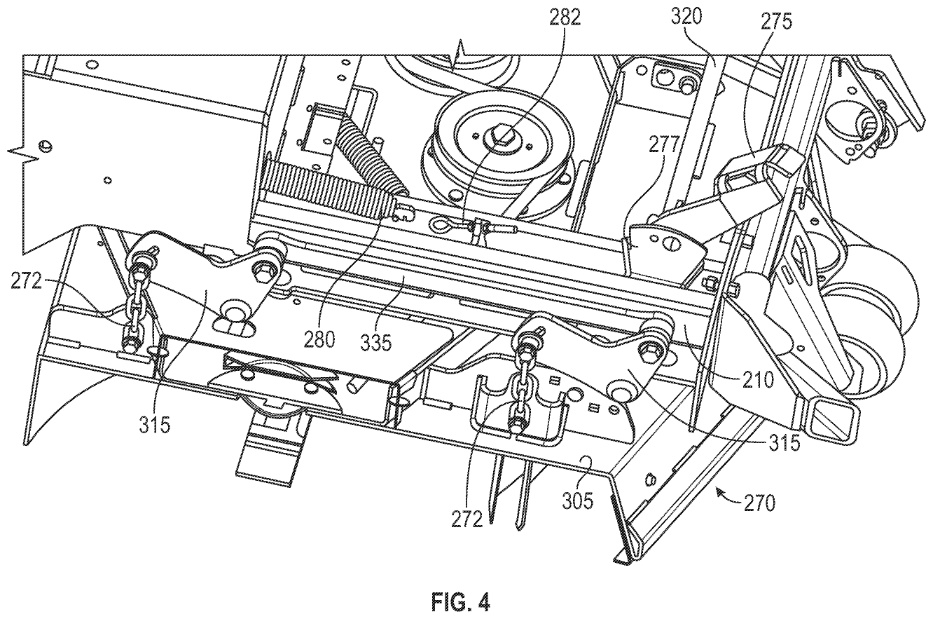

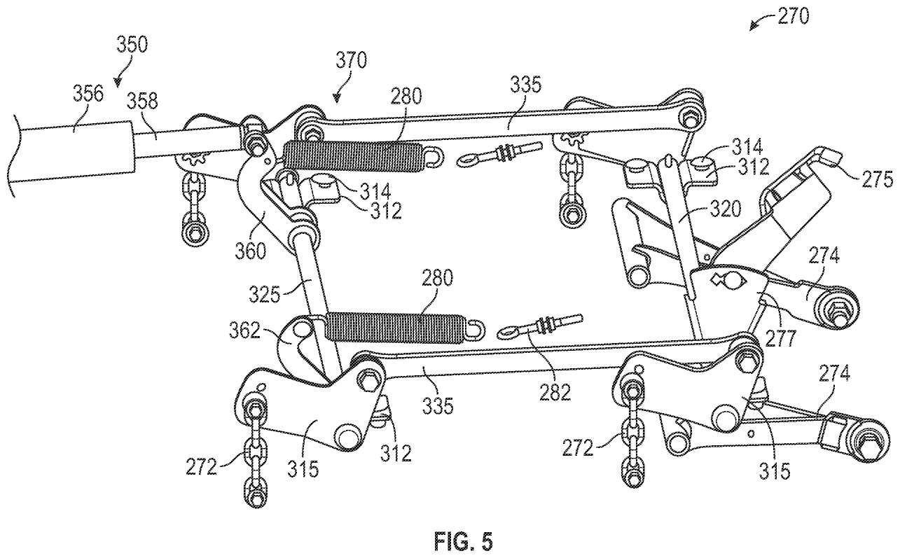

Shown in FIG. 3 is a perspective view of mower deck 230 and suspension system 270 in accordance with one exemplary embodiment. FIG. 4 illustrates a portion of the mower deck 230 and suspension system 270, with the suspension system attached to the mower frame 210 (shown in FIG. 2). FIG. 5 illustrates components of the suspension system 270 alone. As can be seen in FIG. 3, mower deck 230 has a housing 305 which is suspended from the suspension system by a set of chains 272 or suitable connectors. The mower deck housing 305 is stabilized by one or more rigid stabilizing links 274, which pivotally connect the mower deck housing to the mower frame 210 at joint 276 (as shown in FIG. 2). This allows the mower deck housing to be raised and lowered while suspended by chains 272, but prevents the mower deck from moving sideways or forward/backward relative to the machine frame. The mower deck housing houses one or more cutting blades (not shown) under the deck top, and provides an interface to the mower power source which powers rotation of the blades. For example, in some embodiment the blades are driven by a system of one or belts in a belt/pulley system 307 that are operably coupled to an output of an engine. Other blade drive mechanisms can be used, for example including the use of electric motors that are coupled directly or indirected to the one or more blades and are powered by an electric actuator instead of an engine.

Suspension system 270 includes an height adjustment actuator 350 and a mechanical translation mechanism or system 370 which translates actuation position of the actuator to a height position of the mower deck suspended from the mechanical translation mechanism by a set of chains 272 or other suitable connection devices. The mower deck housing 305 has a set of four fixed brackets 310, with two brackets on each side of the housing, one toward the front of the housing and one toward the rear of the housing. Each chain 272 is connected between one of the fixed brackets 310 and an L-shaped bracket 315 of the suspension system 270. The suspension system 270 also includes a forward cross-member 320 and a rear cross-member 325, with one of the L-shaped brackets coupled or attached on each side of the cross-members at a connection point 330 such that the front L-shaped brackets rotate with the front cross-member 320, while the rear L-shaped brackets rotate with the rear cross-member 325, about an axis that extends through each of the connection points 330. The cross-members 320 and 325 thus translate rotational motion from one side of the suspension system to the other side. A pair of links 335 connect the L-shaped brackets 315 on each side of the mower deck housing 305, with each link pivotally coupled to connection the front and rear L-shaped brackets on the corresponding side of the housing at pivot connections 340. The links 335 connect cross-members 320 and 325 together and thus coordinates rotational motion between the rear links to the front links.

Referring for the moment to FIGS. 4 and 5, the mower deck housing 305 is shown coupled to the mower frame 210 by suspension system 270. A set of brackets 312 (best shown in FIG. 5), each including a channel in which one of cross-members 320 and 325 is supported and allowed to rotate within, mounts the cross-members of the suspension system to mower frame 210. Although the mower frame is not shown in FIG. 5, bolts or other fasteners 314 extend through frame 210 and brackets 312 to mount the cross-members to the mower frame. The cross members are thus carried in brackets 312 and allowed to rotate with respect to the mower frame.

Referring now to FIGS. 3, 5 and 6, suspension system 270 further includes an actuator 350 used in exemplary embodiments to control the mower deck height. Actuator 350 is, in an example embodiment, an electric actuator having an electric motor 352, drive gears 354 coupled to the electric motor, and a linear actuator mechanism 356 coupled to the drive gears. In some exemplary embodiments, actuator 350 is a push only linear actuator. As such, the actuator is configured to apply a large force to extend a rod 358 of the linear actuator to a commanded position and to prevent the rod from being pushed in or retracted by external forces from the commanded position, but applies no force or a minimal force to prevent the rod from being pulled into an extended position beyond the commanded extended position. Thus, when an operator commands that the mower deck housing be raised, rod 358 will be extended to a corresponding commanded position. At the commanded position, actuator 350 can apply a push force to prevent the rod from being pushed by external forces into a retracted position, but actuator 350 does not apply a pull force to prevent external forces from pulling the rod into a further extended position.

Rod 358 of actuator 350 is pivotally coupled to a first end of an actuator link 360. A second end of the actuator link 360 is connected to rear cross-member 325 such that extension of rod 358 causes a moment force on and rotation of rear cross-member 325 in a first direction (e.g., clockwise in FIGS. 3-6), thereby converting a linear movement of the actuator to a rotational movement. A second link 362, similar to actuator link 360, can also be connected to rear cross-member 325 to provide a connection point for springs 280 to assist in a lifting operation as will be discussed later in further detail. Through connections between the cross-members and corresponding L-shaped brackets 315, and through connections between L-shaped brackets and links 335, extension of rod 358 also causes the moment force in the first direction to be transferred to front cross-member 320 such that all four L-shaped brackets 315 are rotated in the first direction, which raises mower deck housing 305. The weight of the mower deck 230 applies a moment force, via the connection through chains 272, in a second direction (e.g., counter-clockwise in FIGS. 3-6) which is opposite the first direction. This second moment force applies a force through actuator link 360, which pushes rod 358 toward a retracted position. However, the push force applied by actuator 350 opposes this second moment force and the mower deck height is maintained at the commanded position. If the operator commands that the mower deck height be lowered, the actuator 350 adjusts and only applies the push force to oppose the gravitationally sourced moment when the rod 358 reaches the new actuated position. Therefore, the rod 358 is retracted by this second moment force, caused by the weight of the mower deck, and not by a pull force generated by the actuator 350. In this arrangement, the mower deck is raised by a controlled extension of the actuator rod 358, and lowered by retraction of the actuator rod 358. In some embodiments, the actuator rod isn't affirmatively driven to a retracted position, but is capable (by removal of a push force) of being retracted by the weight of the mower deck acting upon the actuator rod through the actuator link 360.

As discussed, using some actuators such as electric actuator 350 to raise and lower the height of mower deck 305 takes a sufficient enough length of time that doing so many times per day would have a significant cumulative impact on total time lost doing this task. In some embodiments, a foot pedal override mechanism is provided to allow the mower deck to be more quickly raised to avoid obstacles, and then quickly lowered again to the commanded height controlled by actuator 350 so that the mower can resume work. Foot pedal 275 is positioned above a portion of mower frame 210 such that an operator can press the foot pedal from the operator seat or station while operating the mower. Foot pedal 275 is connected through a bracket 277 to front cross-member 320 of suspension system 270, and when an operator pushes the foot pedal forward, a moment force is applied and cross-member 320 rotates in the first direction (clockwise from the perspectives of FIGS. 3-6). Through the connections of the L-shaped brackets 315 and the links 335, this causes all L-shaped brackets 315 to rotate and mower deck 315 to be raised.

As discussed, in embodiments in which actuator 350 is a push only linear actuator, rod 358 can be freely pulled into the required extended position, beyond the extended position commanded by the actuator corresponding to the desired deck height for cutting. This allows the deck height to be quickly raised with the foot pedal without expending the time which would be required to further extend the rod 358 under power of the actuator 350. When the obstacle has been cleared, the operator can quickly return the mower deck to the height commanded by the actuator 350 by removing the push force from the pedal 275 and allowing the weight of the mower deck to apply the second moment force to push in the rod 358. When the rod is pushed in by this external force to the point of the actuated position of actuator 350, the actuator applies force to prevent further retraction of the rod. This returns the mower deck to the commanded height.

As the weight of the mower deck can be several hundred pounds, in exemplary embodiments springs 280 are included to reduce the force required from the operator to raise the mower deck. Springs 280 can be coupled on one end to corresponding ones of links 360 and 362, and on the other end to the mower frame 210. For example, in the illustrated embodiments, adjustable eyelet connectors 282 are attached to either side of the mower frame 210 and are configured to connect to the second ends of springs 280. Eyelet connectors 282 allow adjustment of the spring length and thereby allow adjustment of the amount of force required by an operator to raise the mower deck using the foot pedal.

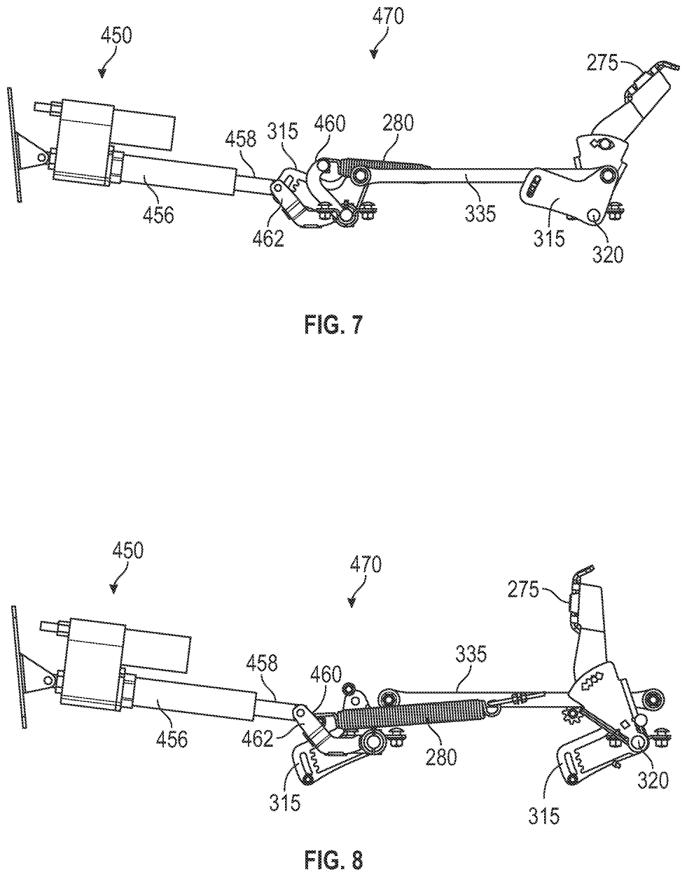

Referring now to FIGS. 7 and 8, shown is an alternative suspension system 470 in accordance with other exemplary embodiments. Suspension system 470 is similar to suspension system 270, and like components are labeled with the same reference numbers. In suspension system 470, instead of a push only actuator, a conventional push-pull actuator 450 is utilized. That is, actuator 450 has a linear actuator mechanism 456 which not only applies a push force to extend rod 458, but also applies a pull force to retract the rod when commanded, and opposes further extension of rod 458 by external forces. Thus, the foot pedal 275 cannot further extend rod 458 beyond its commanded actuated position.

To provide the foot pedal override feature discussed above, while using a conventional push-pull actuator 450, suspension system 470 decouples link 460 (corresponding to link 360 in suspension system 270) from the rod 458 of actuator 450. Instead, as rod 458 is extended or retracted, a seating bracket 462 pivotally attached to the end of the rod is rotated forward or backward to a position which dictates the height of the mower deck housing 305. Link 460 is allowed to rotate forward (clockwise in the view of FIGS. 7-8) from seating bracket 462, with L-shaped brackets 315, when foot pedal 275 is pressed by the operator. This allows the mower deck housing to be temporarily raised in a manner similar to that discussed above. This is shown for example in FIG. 7. However, absent the external force from the foot pedal, the weight of the mower deck rotates the L-brackets 315 and link 460 in the opposite direction (counter clockwise in FIGS. 7-8) until rotation of link 460 is stopped by seating bracket 462 as shown in FIG. 8. This returns the mower deck housing height to the commanded height controlled by the extended position of rod 458.

The disclosed embodiments provide some important advantages. By providing an actuator to control the height of the mower deck, an operator can set a preferred mowing height by using various acceptable operator inputs without having to physically manipulating the mower weight and its corresponding weight. In addition, providing a pedal to allow for momentary deck raising, an operator can easily avoid obstacles during operation and have the deck quickly and accurately be returned to a commanded mower height with minimal effort on the part of the operator.

Although the present invention has been described with reference to preferred embodiments, workers skilled in the art will recognize that changes may be made in form and detail without departing from the scope of the discussion.

What is claimed is:

1. A mower comprising:
a mower frame;
a mower deck housing one or more cutting blades;
a deck suspension system coupling the mower deck to the mower frame, the deck suspension system configured to control a height of the mower deck and to allow the height of the mower deck to be adjusted, the deck suspension system comprising:
an actuator coupled to the mower frame;
a mechanical translation system coupled between the actuator and the mower deck, the mechanical translations system configured to translate actuation positions of the actuator to height positions of the mower deck such that the actuator controls the height position of the mower deck;
a mechanical operator input coupled to the mechanical translation system, wherein the mechanical translation system is further configured to allow height positions of the mower deck to be temporarily raised by actuation of the mechanical operator input without further actuation of the actuator.

2. The mower of claim 1, wherein the mechanical operator input is a foot pedal.

3. The mower of claim 2, wherein the actuator and mechanical translation system are configured such that for a first actuated position of the actuator, the mower deck is positioned at a first height, and wherein the mechanical translation system is further configured such that actuation of the foot pedal from a first foot pedal position to a second foot pedal position causes the mower deck to be raised to a second height higher than the first height while the actuator remains at the first actuated position.

4. The mower of claim 3, wherein the actuator is a push only linear actuator having an actuator rod, wherein the actuator is configured to apply force to extend the rod to commanded positions and to prevent the rod from being pushed in or retracted by external forces from the commanded positions, and wherein the actuator is unable to retract the rod under power or to prevent the rod from being pulled into an extended position beyond the commanded positions.

5. The mower of claim 4, wherein the mechanical translation system is configured such that the rod of the linear actuator is pulled from the first actuated position to a second position corresponding to the second mower deck height when the foot pedal is actuated from the first foot pedal position to the second foot pedal position.

6. The mower of claim 5, wherein the mechanical translation system is configured such that the rod of the linear actuator is pushed from the second position back to the first actuated position, when the foot pedal is no longer actuated, by a force generated from gravitational forces from the weight of the mower deck.

7. The mower of claim 6, wherein the mechanical translation system comprises:
a first cross-member;
a second cross-member;
first and second L-shaped brackets connected to the first cross-member such that rotation of the first cross-member causes rotation of the first and second L-shaped brackets;
third and fourth L-shaped brackets connected to the second cross-member such that rotation of the second cross-member causes rotation of the third and fourth L-shaped brackets;
a first link coupled between the first and third L-shaped brackets such that rotation of either of the first and third L-shaped brackets causes rotation of the other of the first and third L-shaped brackets;
a second link coupled between the second and fourth L-shaped brackets such that rotation of either of the second and fourth L-shaped brackets causes rotation of the other of the second and fourth L-shaped brackets, wherein the mower deck is suspended from the first, second, third and fourth L-shaped brackets such that rotation of the L-shaped brackets raises or lowers the mower deck; and
an actuator link having a first end pivotally coupled to an end of the rod of the linear actuator and having a second end coupled to one of the first and second cross-members such that extension of the rod of the actuator causes rotation of the first and second cross-members and of the L-shaped brackets.

8. The mower of claim 3, wherein the actuator is a push-pull linear actuator having an actuator rod, wherein the actuator is configured to apply force to extend the rod to commanded positions and to prevent the rod from being pushed in or retracted by external forces from the commanded positions, and wherein the actuator is further configured to apply a force to retract the rod under power or to prevent the rod from being pulled into an extended position beyond the commanded positions.

9. The mower of claim 8, wherein the mechanical translation system is configured such that the rod of the linear actuator remains at the first actuated position when the foot pedal is actuated from the first foot pedal position to the second foot pedal position corresponding to the second mower deck height.

10. The mower of claim 8, wherein the mechanical translation system comprises:
a first cross-member;
a second cross-member;
first and second L-shaped brackets connected to the first cross-member such that rotation of the first cross-member causes rotation of the first and second L-shaped brackets;
third and fourth L-shaped brackets connected to the second cross-member such that rotation of the second cross-member causes rotation of the third and fourth L-shaped brackets;
a first link coupled between the first and third L-shaped brackets such that rotation of either of the first and third L-shaped brackets causes rotation of the other of the first and third L-shaped brackets;
a second link coupled between the second and fourth L-shaped brackets such that rotation of either of the second and fourth L-shaped brackets causes rotation of the other of the second and fourth L-shaped brackets, wherein the mower deck is suspended from the first, second, third and fourth L-shaped brackets such that rotation of the L-shaped brackets raises or lowers the mower deck;
a seating bracket having a first end pivotally coupled to an end of the rod of the linear actuator such that extension of the rod of the actuator causes rotation of the seating bracket to a seating bracket position corresponding to the first height of the mower deck; and
an actuator link configured to be seated by the seating bracket and to rotate with the seating bracket with extension of the rod of the actuator, the actuator link having a first end pivotally coupled to one of the first and second cross-members such that extension of the rod of the actuator causes rotation of the seating bracket, the actuator link, the first and second cross-members and the L-shaped brackets, wherein the actuator link is configured to rotate from seating bracket, while the seating bracket remains at the seating bracket position corresponding to the first height of the mower deck, with the first and second cross-members and with the L-shaped brackets when the foot pedal is actuated from the first foot pedal position to the second foot pedal position to raise the mower deck to the second height.
